(19) United States
(12) Patent Application Publication
(10) Pub. No.: US 2006/0136434 A1
(43) Pub. Date: Jun. 22, 2006

(54) System and method for managing objects in a server namespace

(76) Inventors: Susan Lynn Campbell, Cupertino, CA (US); Arunachalam Kandambakkam, Cupertino, CA (US); Ken Lee, San Jose, CA (US); Peter Wolfe, Clarksburg, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/019,336

(22) Filed: Dec. 21, 2004

(51) Int. Cl. G06F 17/00

(52) U.S. Cl. 707/100

(57) ABSTRACT

Methods of managing objects in a server namespace are presented including the steps of: creating at least one schema; populating a server namespace in accordance with the at least one schema such that a server namespace is populated with server related object instances defined by the at least one schema; selecting a server; and graphically displaying all server related object instances in the server namespace for a selected server. In some embodiments, methods are presented further including: selecting a server related object instance; and operating upon the server related object instance. In some embodiments, the at least one schema includes: at least one created class; a superclass of the at least one created class; at least one class property; and at least one association object wherein the association object belongs to an association class.

### BACKGROUND

Clustered computing systems were conceived, in part, to allow users to more efficiently handle processing tasks. By connecting two or more computers together in such a way that they behave like a single computer, a clustered computing system may be created. Clustering may be used for parallel processing, load balancing, high availability, and fault tolerance. Clustering is a popular strategy for implementing parallel processing applications because it enables companies to leverage an investment already made in PCs, workstations, and servers and because it's relatively easy to add new CPUs simply by adding a new PC to the network.

As the development of clustered systems has progressed, the management of clusters and associated cluster subsystems and cluster processes has become increasingly complex. This is in addition to the challenge of managing the operating system and other aspects of the individual systems (PCs, workstations, servers) comprising the cluster. Systems management has evolved to take advantage of an object-oriented management scheme, which can be applied to clusters as well. In this management scheme, “entities” such as servers, network interface cards, processes, and operating systems, for example, may each be represented as an object. Objects may then be placed in a common grouping scheme known as a namespace with each object having a unique name within that namespace. Grouping associated objects in namespaces allowed network administrators to efficiently manage clustered components. However, as the size of clustered systems and the number of associated cluster components grew, so did the number and types of managed objects. As a result of this growth, network administrators were faced with an increasingly unwieldy set of objects to manage first because an administrator may be unable to readily differentiate between all types of objects and second because associations between objects may be difficult to discern.

One strategy developed for handling these large sets of objects was to create private namespaces. Private namespaces could be configured to receive a smaller set of objects that might be related in some way. For example, a private namespace could be made to hold cluster objects. In other examples, a private namespace could be made to hold all operating system objects; objects related to a performance optimization view of a system; or objects relative to a particular hardware or software technology. In this manner, objects could be divided into logical groupings to reduce the number of objects for any given grouping.

This strategy is illustrated in FIG. 1. FIG. 1 is a simplified graphical representation of a way in which namespaces may be organized. For example, a managed namespace 104 designated as root/cimv2 may be populated with any number of system objects (e.g., computer system objects, network interface card objects, disk object, etc.). The designation of root/cimv2 conforms to the Web Based Enterprise Management (WBEM) standard by the Distributed Management Task Force (DMTF). Typically, managed namespace 104 represents a commonly known and utilized namespace. Objects related to specific views may be placed into any number of private namespaces 108, 112, etc. As an example, private namespace 108 at a location designated as root/cimv2/database may contain objects relevant to a database application (e.g., address database, sales database, data warehouse, etc.). Likewise, private namespace 112 at a location root/cimv2/cluster may contain objects relevant to a cluster implementation (e.g., cluster node 1, cluster node 2, etc.). Other private namespaces may also be created and populated depending on what entities are to be managed, and the management software choices regarding making the necessary objects available to administrators and management applications. These private namespaces 100 may be unique to a given application or particular view of the managed entities (e.g., objects related to a cluster). In this manner, related cluster components may be selectively grouped so as to facilitate more efficient management of a cluster.

However, this method is not without drawbacks. For example, namespace 104 may or may not be populated with a complete set of cluster and non-cluster related objects. For any given application or view, not all cluster and non-cluster related objects may be needed. Thus, management software may create a private namespace and populate this private namespace only with objects directly related to an application or view. This strategy may reduce the total number of objects in a given managed namespace, therefore simplifying their creation and/or population, since management software can ignore any objects it does not directly own. However, a system administrator or management application needs to manage not only that one application or view, but also a variety of other applications and views. Thus, this technique shifts the burden to the system administrator or management application to find objects in the system namespace and all private namespaces and determine how they are related. This is necessitated at least in part by a preference to reduce the working set of objects to a manageable level. Unfortunately, this strategy may result in undesirable results.

First, in populating objects into a private namespace, superclasses must be included, so that inheritances will function as desired. Thus, a private namespace will contain superclasses which are also present in a system namespace and perhaps other private namespaces as well. Multiple copies of these superclasses raise the issue of consistency: it is now more difficult to make sure all copies are identical. Second, a new namespace is understandably less rich in that it will only contain some limited subset of the objects which populate the system namespace. Third, in private namespaces, associations between objects may be lost or obscured thus rendering administration more tedious as it may be left solely to an administrator to ferret out all associations when dealing with cluster issues. For example, it may be difficult to correlate the cluster network interconnect object in the cluster private namespace with the appropriate Network Interface Card in the system namespace of each server member, or even correlate the concept of a cluster member with the system objects.

Therefore, system and methods for managing objects in a server namespace are presented.

### SUMMARY

The present invention presents methods of creating a schema including: selecting a first class; defining at least one object association for the first class; and creating a schema for the first class and for the at least one object association for the first class. In some embodiments, methods further include: selecting a superclass for the first class; and defining at least one property for the first class. In some embodiments, the schema includes: a name for the first class, a name for the superclass, and the at least one property.

In other embodiments, methods of populating a server namespace with server related object instances are presented including the steps of: a) selecting a cluster aware object instance where the cluster aware object instance is a server related object instance; b) selecting a corresponding non-cluster aware object instance corresponding to the cluster aware object instance as defined by a schema where the non-cluster aware object instance is a server related object instance; c) building an association object instance such that the selected cluster aware object instance and the corresponding non-cluster aware object instance relationship is defined; and d) populating a server namespace with all cluster aware object instances and all corresponding non-cluster aware object instances such that all server related object instances reside in a single namespace. In some embodiments, the association object instance includes at least two endpoints such that the cluster aware object instance and its corresponding non-cluster aware object instance are correctly identified. In some embodiments, methods are presented further including repeating the steps a), b) and c) for all cluster aware object instances. In some embodiments, methods are presented further including before step a): selecting a cluster member; finding a schema corresponding to the cluster member; retrieving cluster information corresponding to selected cluster member; and building at least one cluster aware object instance from retrieved cluster information.

In still other embodiments, methods of managing objects in a server namespace are presented including the steps of: selecting a server of interest; examining a server namespace corresponding to the server of interest enumerating all cluster class instances in the server namespace; and determining whether the server of interest is a member of a cluster. In some embodiments, methods are presented further including: if the server of interest is a member of a cluster, getting all server related object instances corresponding to the server of interest where at least one server related object instance is an association object instance corresponding to a cluster aware object instance and a corresponding non-cluster-aware object instance; determining a current server of the cluster; and displaying the current server of the cluster and all server related object instances. In some embodiments, methods are presented further including: selecting a server related object instance; and operating upon the server related object instance.

In still other embodiments, integrated methods of managing objects in a server namespace are presented including the steps of: creating at least one schema; populating a server namespace in accordance with the at least one schema such that a server namespace is populated with server related object instances defined by the at least one schema; selecting a server; and graphically displaying all server related object instances in the server namespace for a selected server. In some embodiments, methods are presented further including: selecting a server related object instance; and operating upon the server related object instance. In some embodiments, the at least one schema includes: at least one created class; a superclass of the at least one created class; at least one class property; and at least one association object wherein the association object belongs to an association class.

In still other embodiments a server namespace is presented including: at least one cluster aware object instance; at least one non-cluster aware object instance corresponding to at least one cluster aware object instance; and at least one association object instance wherein the at least one association object defines a relationship between the at least one cluster aware object instance and the at least one non-cluster aware object instance. In some embodiments, the at least one association object includes at least two endpoints such that one endpoint corresponds to the cluster aware object instance and one endpoint corresponds to the non-cluster aware object instance.

In still other embodiments, a computer program product for use in conjunction with a computer system for managing objects in a server namespace is presented, the computer program product comprising a computer readable storage medium and a computer program mechanism embedded therein, the computer program mechanism including: instructions for creating at least one created schema; instructions for populating a server namespace in accordance with the at least one created schema such that the server namespace is populated with server related object instances defined by the at least one created schema; instructions for enabling server selection; and instructions for graphically displaying all server related object instances in the server namespace for a server. In some embodiments, the computer program product is presented further including: instructions for enabling selection of a server related object instance; and instructions for enabling operations upon the server related object instance after selection.

In still other embodiments integrated methods of managing objects in a server namespace are presented including the steps of: means for creating at least one schema; means for populating a server namespace in accordance with the at least one created schema such that a server namespace is populated with server related object instances defined by the at least one created schema; means for selecting a server; and means for graphically displaying all server related object instances in the server namespace for a selected server. In some embodiments, methods further include: means for selecting a server related object instance; and means for operating upon the server related object instance after selection. In some embodiments, the at least one schema includes: at least one created class; a superclass of the created class; at least one class property; and at least one association object wherein the association object belongs to an association class.

### BRIEF DESCRIPTION OF THE DRAWINGS

Embodiments of the invention may best be understood by reference to the following description taken in conjunction with the accompanying drawings in which:

FIG. 1 is a simplified graphical representation of a way in which objects may be organized into multiple namespaces;

FIG. 2 is a graphical illustration of a cluster inheritance diagram in accordance with an embodiment of the present invention;

FIG. 3 is a graphical illustration of a cluster instance diagram in accordance with an embodiment of the present invention;

FIG. 4 is a functional block diagram illustrating an overview in accordance with an embodiment of the present invention;

FIG. 5 is a flowchart illustrating a method of designing a schema in accordance with an embodiment of the present invention;

FIGS. 6A-B illustrate a flowchart demonstrating a method of populating a server namespace in accordance with an embodiment of the present invention;

FIG. 7 is a flowchart illustrating one use of a server namespace in accordance with an embodiment of the present invention;

FIG. 8 is a flowchart illustrating a method of deploying an embodiment of the present invention; and

FIG. 9 is a simplified graphical representation of an association object and its component parts in accordance with an embodiment of the present invention.

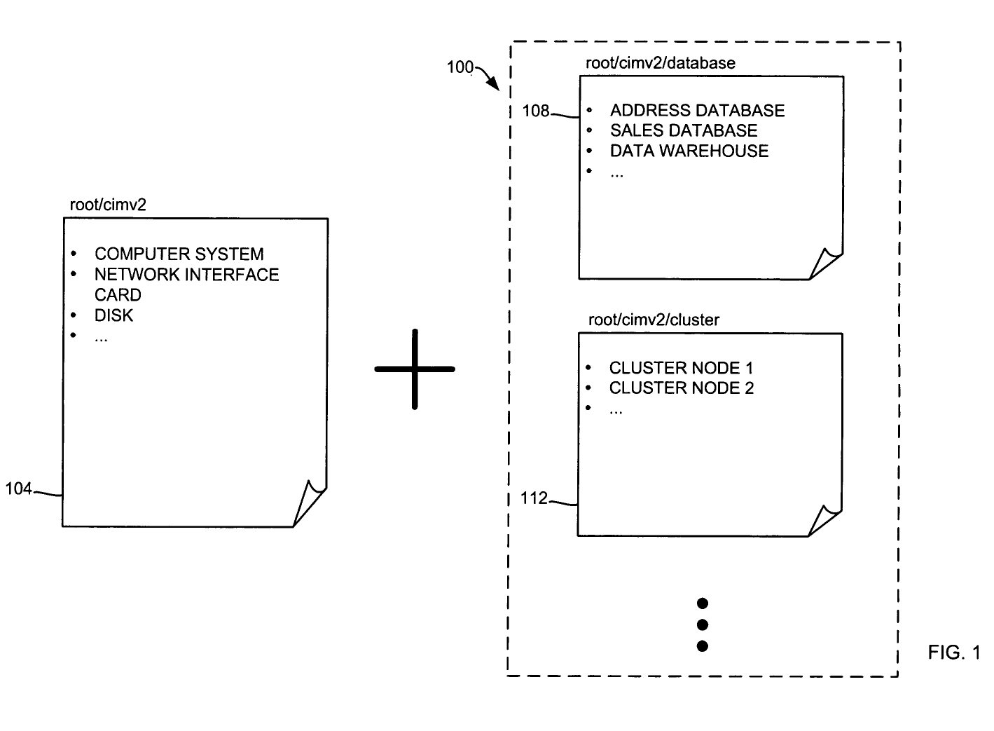

### DETAILED DESCRIPTION

The present invention will now be described in detail with reference to a few embodiments herein as illustrated in the accompanying drawings. In the following description, numerous specific details are set forth in order to provide a thorough understanding of the present invention. It will be apparent, however, to one skilled in the art that the present invention may be practiced without some or all of these specific details. In other instances, well known process steps and/or structures have not been described in detail in order to not unnecessarily obscure the present invention.

In accordance with embodiments of the present invention, there are provided systems and methods for managing objects in a server namespace. Embodiments of the present invention allow a user to more effectively administer clusters and cluster-related objects.

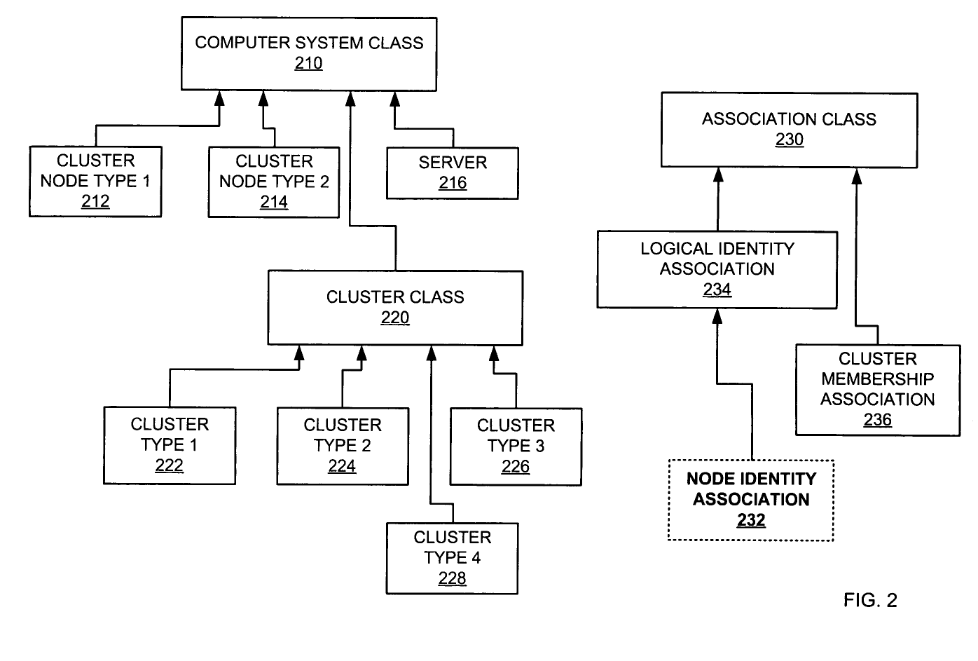

Referring first to FIG. 2, FIG. 2 is a graphical illustration of an example cluster inheritance diagram in accordance with an embodiment of the present invention. In particular, computer system class 210 is a superclass of various classes. Cluster node types classes 212 and 214 represent any number of different types of cluster node objects and are subclasses of computer system class 210. Servers (e.g., class 216) are also subclasses of computer system class 210. Cluster node objects belonging to these classes may be generic or may be product specific. For example, if a cluster implementation has a need for special properties not found in superclass 210, those properties may be added in subclasses 212 and 214. Server class 216 may represent any number of different types of server objects that are a subclass of computer system class 210. Cluster class 220 is a subclass of computer system class 210 and may comprise any of a number of cluster subclasses. For example, illustrated cluster subclasses 222-228 are subclasses of cluster class 220. The number and type of cluster classes may be varied without limitation, as specific cluster implementations may have a need for specialized properties not found in superclass 220 or other subclasses. As shown, lines connecting the various classes indicate the class from which an originating class inherits. For example, cluster 228 inherits from cluster class 220 which, in turn, inherits from computer system class 210. In this manner, inheritance may conform to standard methods of representing schema as defined by the DMTF.

Also illustrated is an association superclass 230 having children logical identity association class 234 and cluster membership association class 236 as well as a grandchild node identity association class 232. Association class 230 does not inherit from computer system class 210, but may be used to relate a computer system object to the objects corresponding to a particular computer configuration. For example, node identity association 232 may be used to associate a standard server class 216 to a cluster node class 212 or 214. FIG. 2 further illustrates, at a simplified level, some of the various inheritance paths that are possible in a single configuration. As can be appreciated, many more classes may be configured. As the number and type of classes increase, illustrating all inheritance relationships may become increasing difficult. Somewhat related to an inheritance diagram is an instance diagram, which illustrates a logical construction of a clustered computing system configuration based on a population of object instances defined, for example, upon classes as illustrated in FIG. 2.

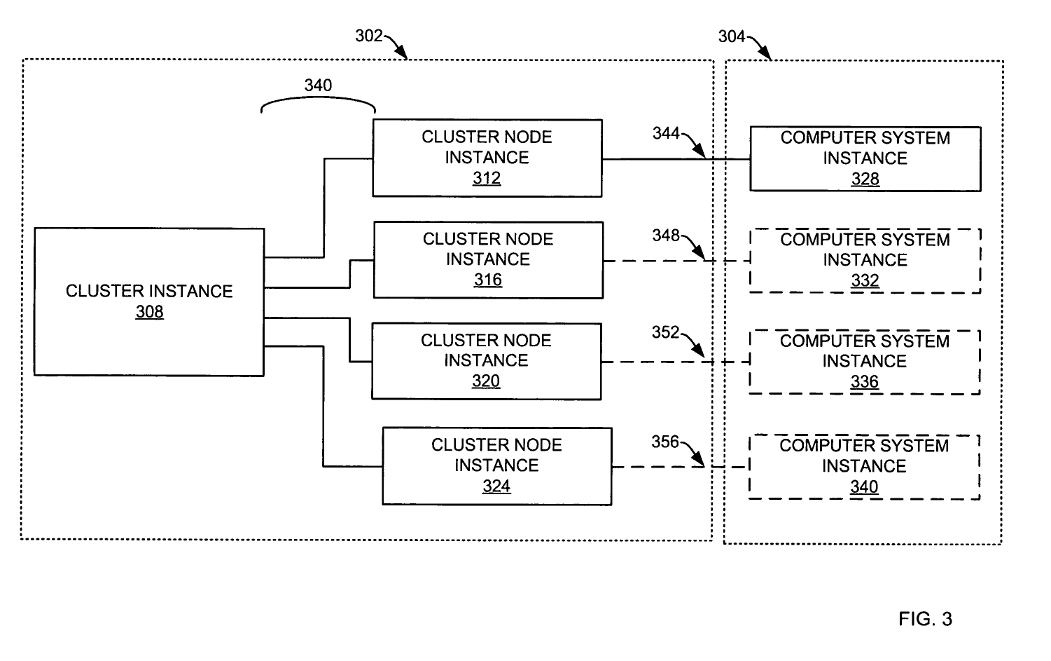

FIG. 3 is a graphical illustration of a cluster instance diagram in accordance with an embodiment of the present invention. In particular, FIG. 3 illustrates examples of five categories of object instances for an example clustered computing system: cluster class instances 308, cluster membership association class instances 340, cluster node class instances 312-324, node identity association class instances 344-356, and computer system class instances 328-340. The diagram is further delineated by cluster aware instances 302, which include instances 308-324 and 344-356 as well as by non-cluster-aware instances 304, which include instances 328-340. Typically, non-cluster-aware instances 328-340 might reside in a system namespace while cluster aware instances 308-340 might reside in one or more private namespace in conventional application examples. Further, the naming conventions used herein are for convenience only and should not be construed as limiting the scope of the present invention.

Thus, cluster instance 308 is illustrated having four cluster node instances 312-324. Cluster node instances 312-324 are associated with cluster instance 308 via associations 340. Associations 340 represent each of four association instances belonging to a class that defines associations between cluster instances and cluster node instances—in this example a cluster membership association class (see FIG. 2, 236). Cluster node instances 312 may be further associated with computer system instances 328-340 via associations 344-356. Associations 344-356 represent association instances belonging to a class that defines associations between cluster node instances and computer system instances in accordance with an embodiment of the present invention. Associations 344-356 belong to node identity association class (see FIG. 2, 232). The dashed lines of association instances 348-356 and computer system instances 332-340 indicate those instances residing in the same namespace as the system whose namespace is currently being examined—in this example, computer system 328.

This problem is further exacerbated because these instances illustrate examples of objects that might be found in any of a number of namespaces. As noted above, one strategy developed for handling large sets of objects or sets of objects representing different views was to create additional private namespaces. For example, if, as noted above, objects 308, 312-324, and 340 resided in a private namespace, and computer system 328 resided in the system namespace, an administrator or management software needs to somehow determine which cluster node (312 or 316 or 320 or 324) is logically related to 328 because associations 344-356 were not available. Another related problem is namespace synchronization. For example, where namespaces are not synchronized, it is possible that a computer system cluster member such as 328 might be dropped from its cluster, but will continue to appear in an unsynchronized namespace.

Still further, an instance diagram may be mapped to an inheritance diagram as illustrated in FIG. 2. For example, computer system instance 328 of FIG. 2 may belong to computer system superclass 210 of FIG. 2. That is, the properties of computer system instance 328 may be described in computer system class 210. Likewise, cluster node instance 312 of FIG. 2 may belong to subclass cluster node type class 212 or 214 of FIG. 2. Still further, cluster instance 308 may belong to any of subclass cluster type 222-228. Still further, node identity association instances 344-356 may belong to node identity association class 232 of FIG. 2 and cluster membership association instance 340 may belong to cluster membership association class 236 of FIG. 2. Thus, while an inheritance diagram illustrates an avenue by which properties traverse different classes, an instance diagram illustrates a logical representation of instances of classes.

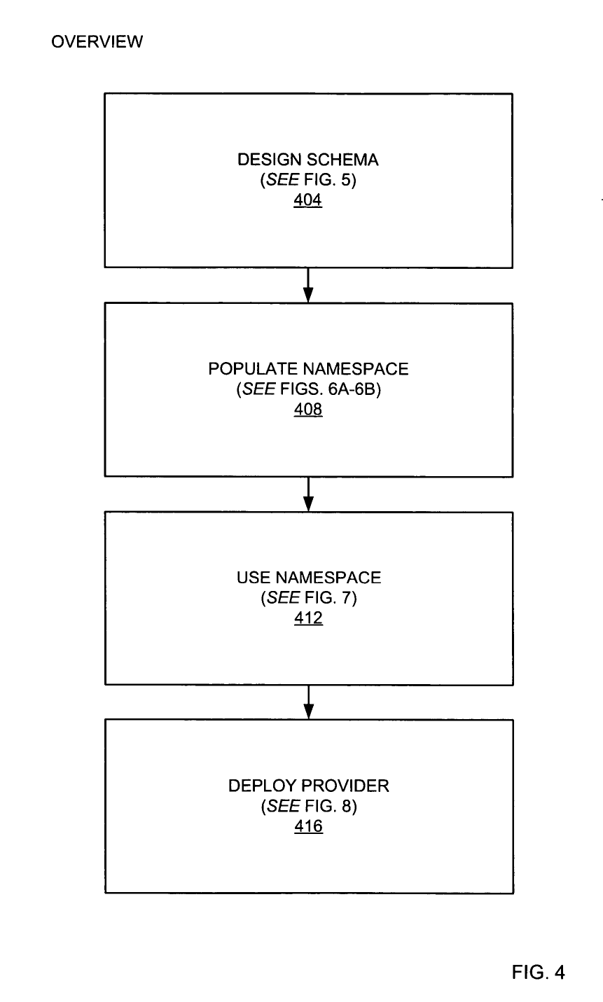

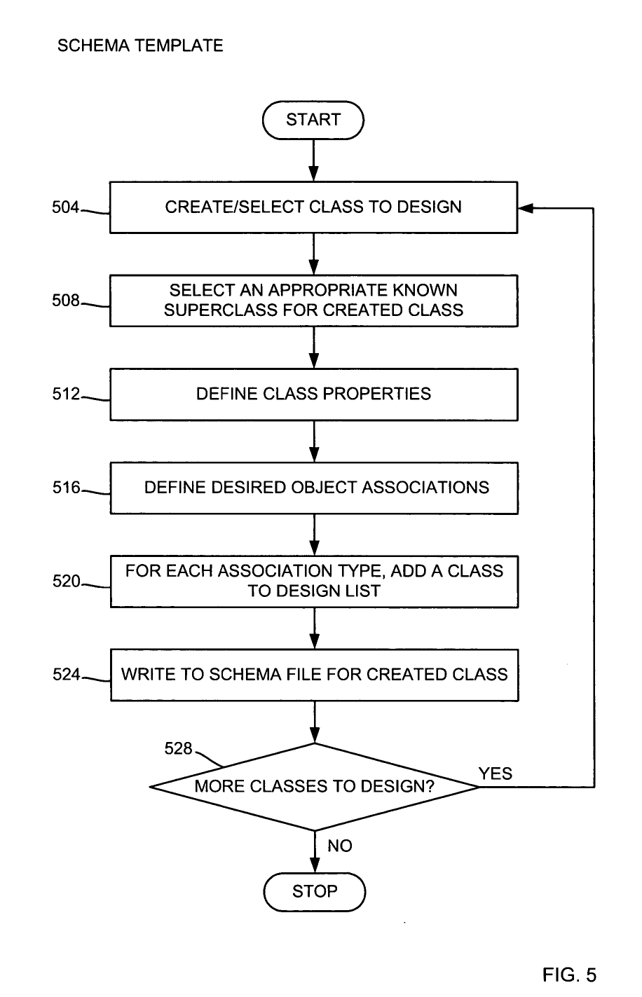

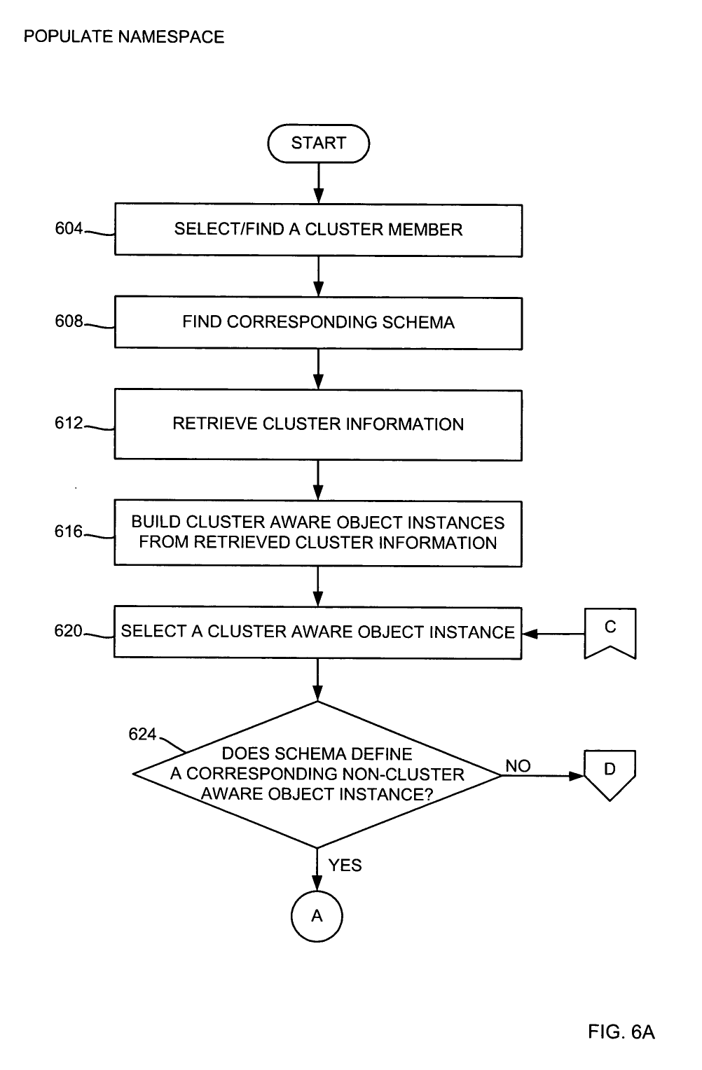

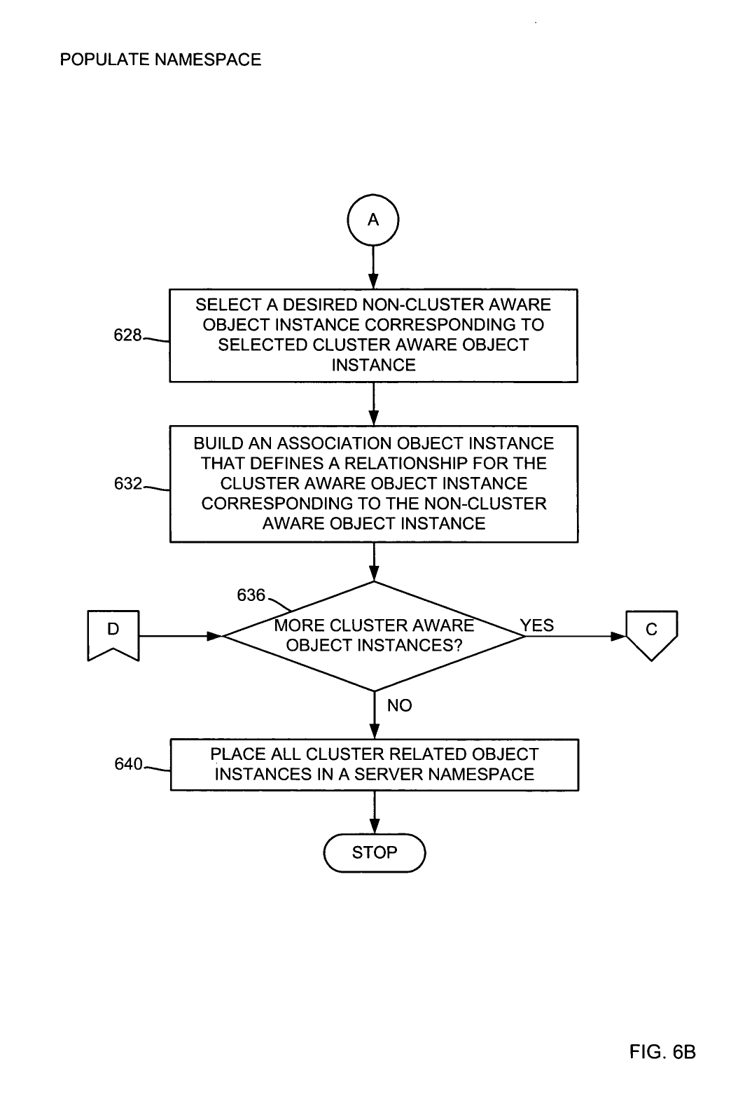

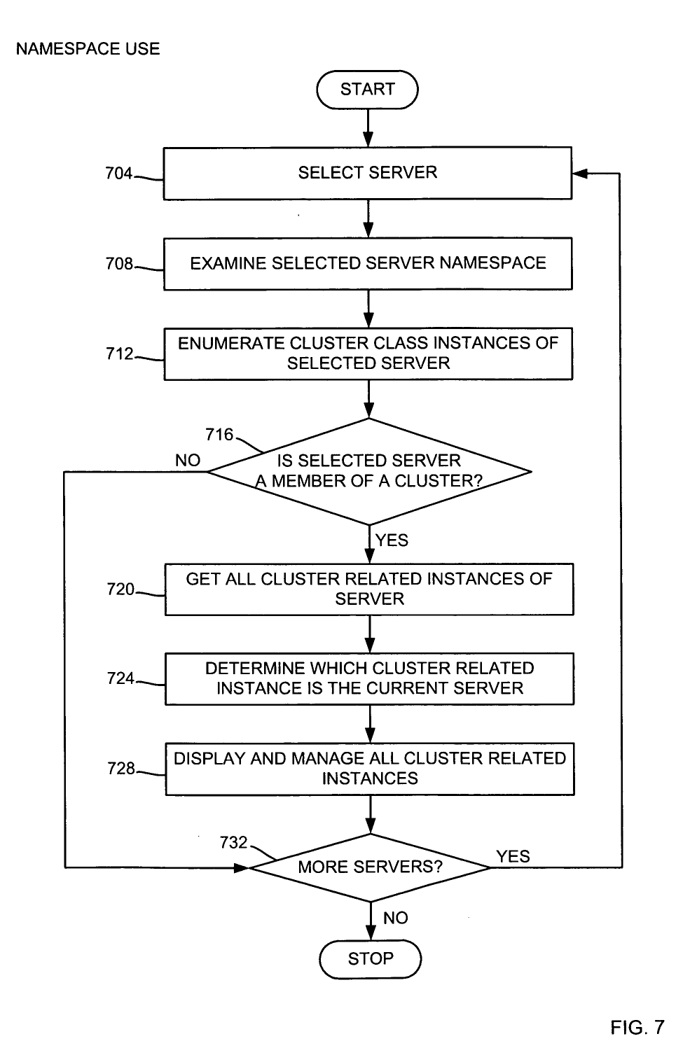

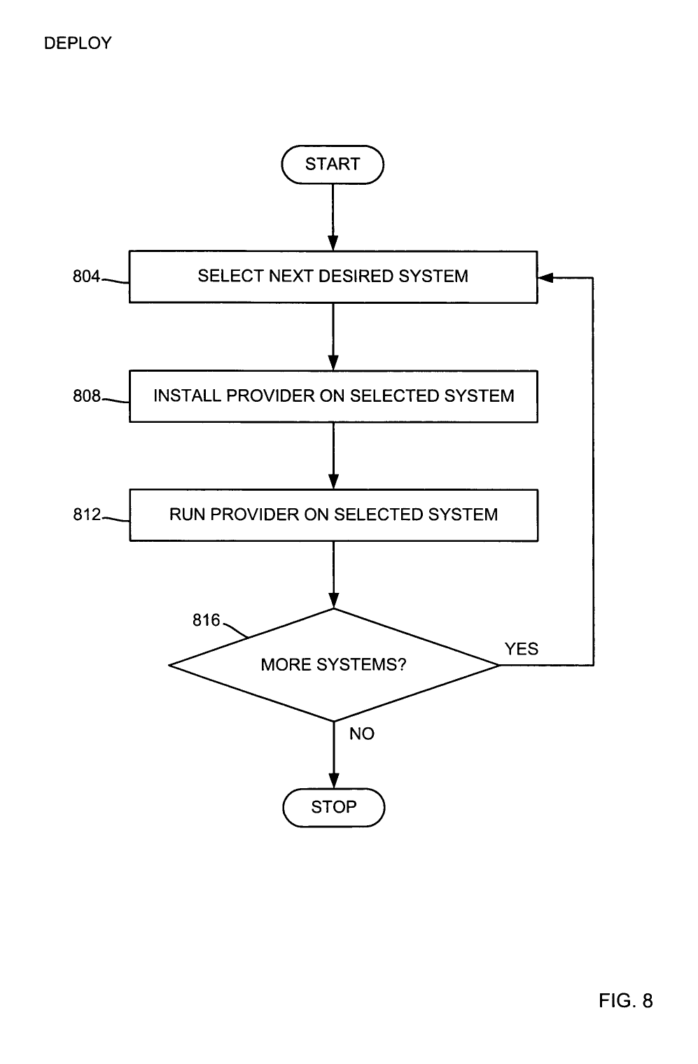

FIG. 4 is a functional block diagram illustrating an overview in accordance with an embodiment of the present invention. This overview is presented to assist in clarify various embodiments of the present invention. Thus, block 404 represents structures and functions of designing a schema under an embodiment of the present invention as described in FIG. 5. Block 408 represents structures and functions of populating a namespace with instances (e.g., see FIG. 3) under an embodiment of the present invention as described in FIGS. 6A-B. Block 412 represents methods of using a namespace under an embodiment of the present invention as described in FIG. 7. Finally, block 416 represents structures and functions of optionally deploying a provider under an embodiment of the present invention as described in FIG. 8.

Referring to FIG. 5, FIG. 5 is a flowchart illustrating a method of designing a schema in accordance with an embodiment of the present invention. At a first step 504, a class is selected or found to design. In the construction of a tool to assist an administrator in managing a objects in a server namespace in one embodiment of the present invention, at least five classes of objects may be created or selected: cluster class, cluster membership association class; cluster node class; node identity association class; and computer system class. Classes may be taken singly or in combination. At a next step 508, an appropriate known superclass is selected for the class created in step 504. In object oriented programming, classes may be created that are subclasses of another class (i.e. superclass or parent class). This allows the created class to inherit the attributes of the parent class without requiring a designer to rewrite the definitions of the class properties. In this manner, the parent class (i.e., superclass) may be efficiently extended to a custom made class (i.e., subclass). In some embodiments, some classes along with their superclass may already exist, in which case the class and corresponding superclass may be selected. In one embodiment, a selected superclass contains a key identifier. A key identifier may be a value or set of values that uniquely identify an object within a namespace.

At a next step 512 class properties may be defined supplementing those inherited from a superclass. Class properties include any relevant information necessary to properly create a class being created. In some embodiments were the class is selected (as opposed to created), defining properties may be omitted as they are already defined in the selected class. At a next step 516, desired object associations may be defined. In some embodiments, object associations include associations between cluster-aware instances. For example, referring briefly to FIG. 3, associations 340 represent associations between cluster aware instances (i.e., the cluster and the cluster node). In other embodiments, associations include associations between cluster aware instances and non-cluster-aware instances. For example, associations 344-356 represent associations between non-cluster-aware instances 328-340 and cluster aware instances 312-324 respectively. Further, associations are themselves object classes.

Turning back to FIG. 5, at a next step 520, a class is added to a design list for each association object type defined at a step 516. For example, for an association such as association 344 (FIG. 3), a class may be designed to which association 344 will belong. Association 344 is an example object instance belonging to class node identity association 232 (FIG. 2). By defining this class (e.g., class 232) within a known class structure, association 344, as an instance of class 232, may inherit from parent logical identity association class 234 (FIG. 2) and grandparent association class 230. A schema may be written to a file for a created class at a step 524. A schema contains class definitions, properties, and any other relevant information regarding created classes to be used at a further step described in FIG. 6 below. The method then determines whether there are more classes to design at a step 528. If there are more classes to design, the method returns to a step 504. If all classes have been designed, the method ends.

Referring now to FIGS. 6A-B, FIGS. 6A-B illustrate a flowchart demonstrating a method of populating a server namespace in accordance with an embodiment of the present invention. A server namespace contains all server related object instances for a particular server. At a first step 604, a cluster member may be selected or found. A server namespace, may be selected or found by any manner well-known in the art. After a cluster member is found, a corresponding schema, such as the schema written to at a step 524 (FIG. 5) may be found at a step 608. As noted above, a schema contains class definitions, properties, and any other relevant information regarding created classes.

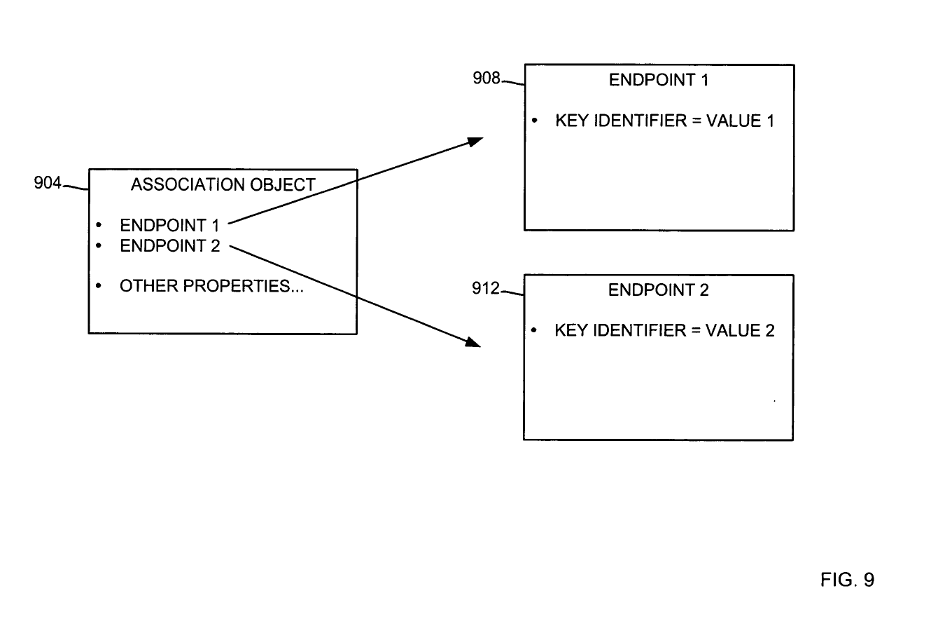

At a next step 612, cluster information corresponding to the schema selected at a step 608 may be retrieved. In some embodiments, cluster information may be retrieved by API's running on a node. Cluster information includes all information regarding all cluster components including, for example, clusters, nodes, and associations. Cluster information may be received and stored in any manner well-known in the art. Once cluster information is received, all cluster-aware object instances may be built at a step 616. In one embodiment, cluster related object instances include, both cluster aware object instances and non-cluster-aware object instances as illustrated in FIG. 3. The method may then select a cluster aware object instance such as, for example a cluster node instance 312 (FIG. 3) at a step 620. The method may then query whether the schema selected at a step 608 defines a corresponding non-cluster-aware object instance at a step 624. If the method finds no defined corresponding non-cluster-aware object instance for the selected cluster aware object instance, the method continues to a step 636, which will be discussed in further detail below for FIG. 6B. If the method determines a defined corresponding non-cluster-aware object instance exists, the method then selects a defined non-cluster-aware object instance such as for example, computer system instance 328 (FIG. 3) at a step 628. The method selects an instance based on a schema, which imposes a logical construction to a cluster of interest. Once a non-cluster-aware object instance has been selected at a step 628, an association object instance may be built at a step 632 that defines a relationship for the cluster aware object instance corresponding to the non-cluster-aware object instance. The structure of this association object instance will be discussed in further detail below for FIG. 9.

The method then determines whether there are more cluster aware object instances at a step 636. If there are more cluster aware object instances in the cluster being processed, the method continues to a step 620 to select another cluster aware object instance. If all cluster aware object instances have been processed, then method then places all cluster related object instance into a server namespace at a step 640. In some embodiments, a server namespace generally exists for every server. By grouping objects in a server namespace in embodiments of the present invention, the need to synchronize objects across namespaces may be eliminated. Further benefits may be realized because objects may be more easily accessed via a known server namespace. The method then ends.

Referring to FIG. 7, FIG. 7 is a flowchart illustrating one use of a server namespace in accordance with an embodiment of the present invention. At a first step 704, a server may be selected. A server may be selected by any manner well-known in the art. For example, a server may be selected from an IP sweep, or an IP address list. In some embodiments, a server may be selected through a related object. For example, a server, such as the server illustrated in FIG. 3, may be selected by querying any of the cluster related object instances shown therein due at least in part to the method in which the related objects were configured as described in FIGS. 6A-B. After a server is selected, a server namespace is examined at a step 708. The server namespace is populated with object instances by methods described for FIGS. 6A-B above. As noted above, a particular advantage of embodiments of the present invention is that all server related objects for a server may reside in a single server namespace, with appropriate relationships explicitly modeled via associations between cluster-aware and non-cluster-aware objects.

At a next step 712, all cluster class instances of a selected server may be enumerated. In this manner, the method may determine, at a next step 716, whether the selected server is a member of a cluster. If the method determines that the selected server is not a member of a cluster, the method continues to a step 732 to select another server. If the method determines that server is a member of a cluster, then the method continues to a step 720 to get all cluster related instances of the server. As noted above for FIG. 3, all cluster related instances include both cluster aware object instances and non-cluster-aware object instances. The method then determines which cluster related instance is the current server. As may be appreciated, a selected server may not be the current server.

At a next step 728, all cluster related instances may be displayed. Cluster related instances may be displayed in any manner well-known in the art including text display and GUI display. As the object instances may also support management, the administrator or management software may be configured to manage (e.g., operate upon) server related objects. The method continues at a step 732 to determine whether more servers to select are desired. If more servers are desired, the method continues to a step 704. If no further servers are desired, the method ends.

Referring to FIG. 8, FIG. 8 is a flowchart illustrating a method of deploying an embodiment of the present invention. In some embodiments, it may be desirable to combine the methods described in FIGS. 5-6. As such, in some embodiments, a provider code may be created that enables those methods on a selected system. One skilled in the art may appreciate that the provider code described herein may be deployed locally or remotely using any computer readable media well-known in the art without departing from the present invention. Thus, at a first step 804, a desired system is selected. Provider code, which embodies the preceding methods, may be installed on the selected system at a step 808. The code may be stored or cached on any computer readable media known in the art. Code may also be stored locally or remotely as desired. The provider code is then run on the selected server at a step 812. In one embodiment, provider code may be run remotely from a target server. A result of the provider code may be a server namespace having all server related object instances which include cluster aware objects and non-cluster-aware objects. Furthermore, provider code may be configured to generate a server namespace in any of several different manners. In one example, a server namespace may be generated at selected temporal intervals one or many times. In other examples, a server namespace may be generated each time the provider code is run. Additionally, provider code may then reside in memory on a selected system awaiting queries. The method then continues to a step 816 to determine whether more systems are available to receive provider code. If more systems are desired, the method continues to a step 804. If no further systems are desired, the method ends.

Referring to FIG. 9, FIG. 9 is a simplified graphical representation of an association object and its component parts in accordance with an embodiment of the present invention. An association object 904 is illustrated having at least two endpoints and optionally some other, undefined properties. Endpoint 908 includes at least one key identifier having a value. Endpoint 912 also includes at least one key identifier having a value. An endpoint describes the connection to another object. Thus, each association connects two objects. For example, referring briefly to FIG. 3, node identity association object 344 includes a first endpoint that describes a connection with cluster node instance 312. This first endpoint is identified by at least one key identifier that, in this example, identifies cluster node instance 312. Node identity association object 344 includes a second endpoint that describes a connection with computer system instance 328. This second endpoint is identified by at least one key identifier that, in this example, identifies computer system instance 328. Other identifiers may be necessary and are contemplated within the scope of the present invention. Furthermore, association object 904 may contain other properties such as name, location, IP addresses, etc., in accordance with the schema defined for that association.

While this invention has been described in terms of several embodiments, there are alterations, permutations, and equivalents which fall within the scope of this invention. For example, although the present invention is primarily described herein as operating in conjunction with Web-Based Enterprise Management (WBEM) and WMI/CIM, the present invention is equally applicable to other management systems, and thus the references herein to WMI/CIM management system are for illustrative purposes only, and do not limit the applicability of the invention It is therefore intended that the following appended claims be interpreted as including all such alterations, permutations, modifications, and various substitute equivalents as fall within the true spirit and scope of the present invention.

What is claimed is:

1. A method of creating a schema comprising:
selecting a first class;
defining at least one object association for the first class; and
creating a schema for the first class and for the at least one object association for the first class.

2. The method of claim 1 further comprising
selecting a superclass for the first class; and
defining at least one property for the first class.

3. The method of claim 2 wherein the schema comprises a name for the first class, a name for the superclass, and the at least one property.

4. The method of claim 1 wherein the first class is a user created class.

5. The method of claim 1 wherein the at least one object association includes an endpoint that is a cluster aware instance.

6. The method of claim 1 wherein the at least one object association includes an endpoint that is a non-cluster aware instance.

7. A method of populating a server namespace with server related object instances comprising:
a) selecting a cluster aware object instance wherein the cluster aware object instance is a server related object instance;
b) selecting a corresponding non-cluster aware object instance corresponding to the cluster aware object instance as defined by a schema wherein the non-cluster aware object instance is a server related object instance;
c) building an association object instance such that the selected cluster aware object instance and the corresponding non-cluster aware object instance relationship is defined; and
d) populating a server namespace with all cluster aware object instances and all corresponding non-cluster aware object instances such that all server related object instances reside in a single namespace.

8. The method of claim 7 wherein the association object instance comprises at least two endpoints such that the cluster aware object instance and its corresponding non-cluster aware object instance are correctly identified.

9. The method of claim 7 further comprising:
repeating the steps a), b) and c) for all cluster aware object instances.

10. The method of claim 9 further comprising before step a):
selecting a cluster member;
finding a schema corresponding to the cluster member;
retrieving cluster information corresponding to selected cluster member; and
building at least one cluster aware object instance from retrieved cluster information.

11. The method of claim 10 wherein the cluster information is retrieved by an API.

12. The method of claim 7 wherein the association object instance further comprises user defined properties.

13. The method of claim 7 wherein the association object instance is a node identity association object instance.

14. The method of claim 13 wherein the node identity association object instance is a subclass of a logical identity association class.

15. A method of managing objects in a server namespace comprising:
selecting a server of interest;
examining a server namespace corresponding to the server of interest;
enumerating all cluster class instances in the server namespace; and
determining whether the server of interest is a member of a cluster.

16. The method of claim 15 further comprising:
if the server of interest is a member of a cluster, getting all server related object instances corresponding to the server of interest wherein at least one server related object instance is an association object instance corresponding to a cluster aware object instance and a corresponding non-cluster-aware object instance;
determining a current server of the cluster; and
displaying the current server of the cluster and all server related object instances.

17. The method of claim 16 further comprising:
selecting a server related object instance; and
operating upon the server related object instance.

18. The method of claim 16 wherein all server related objects are displayed in a graphical user interface.

19. The method of claim 15 wherein a server of interest is selected from the group consisting of: an IP address list, a ping sweep, and a domain name specification.

20. An integrated method of managing objects in a server namespace comprising:
creating at least one schema;
populating a server namespace in accordance with the at least one schema such that a server namespace is populated with server related object instances defined by the at least one schema;
selecting a server; and
graphically displaying all server related object instances in the server namespace for a selected server.

21. The method of claim 20 further comprising:
selecting a server related object instance; and
operating upon the server related object instance.

22. The method of claim 20 wherein the at least one schema comprises:
at least one created class;
a superclass of the at least one created class;
at least one class property; and
at least one association object wherein the association object belongs to an association class.

23. A server namespace comprising:
at least one cluster aware object instance;
at least one non-cluster aware object instance corresponding to at least one cluster aware object instance; and
at least one association object instance wherein the at least one association object defines a relationship between the at least one cluster aware object instance and the at least one non-cluster aware object instance.

24. The server namespace of claim 23 wherein the at least one association object comprises at least two endpoints such that one endpoint corresponds to the cluster aware object instance and one endpoint corresponds to the non-cluster aware object instance.

25. The server namespace of claim 24 wherein the at least one association object instance further comprises user defined properties.

26. The server namespace of claim 23 wherein the at least one association object instance is a node identity association object instance.

27. The server namespace of claim 26 wherein the node identity association object instance is a subclass of a logical identity association class.

28. A computer program product for use in conjunction with a computer system for managing objects in a server namespace, the computer program product comprising a computer readable storage medium and a computer program mechanism embedded therein, the computer program mechanism comprising:
instructions for creating at least one created schema;
instructions for populating a server namespace in accordance with the at least one created schema such that the server namespace is populated with server related object instances defined by the at least one created schema;
instructions for enabling server selection; and
instructions for graphically displaying all server related object instances in the server namespace for a server.

29. The computer program product of claim 28 further comprising:
instructions for enabling selection of a server related object instance; and
instructions for enabling operations upon the server related object instance after selection.

30. The computer program product of claim 28 wherein the at least one created schema comprises:
at least one created class;
a superclass of the created class;
at least one class property; and
at least one association object wherein the association object belongs to an association class.

31. An integrated method of managing objects in a server namespace comprising:
means for creating at least one schema;
means for populating a server namespace in accordance with the at least one created schema such that a server namespace is populated with server related object instances defined by the at least one created schema;
means for selecting a server; and
means for graphically displaying all server related object instances in the server namespace for a selected server.

32. The method of claim 31 further comprising:
means for selecting a server related object instance; and
means for operating upon the server related object instance after selection.

33. The method of claim 31 wherein the at least one schema comprises:
at least one created class;
a superclass of the created class;
at least one class property; and
at least one association object wherein the association object belongs to an association class.
